(19) United States
(12) Patent Application Publication
(10) Pub. No.: US 2006/0128352 A1
(43) Pub. Date: Jun. 15, 2006

(54) Locking latch utilizing in-mold assembly

(75) Inventors: Paul J. Faerber, Chandler, AZ (US); Matthew R. Michieli, Gilbert, AZ (US); Kraig S. Clark, Boulder, CO (US); Monte S. Fry, Longmont, CO (US); David W. Robinson, Slinger, WI (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/011,578

(22) Filed: Dec. 14, 2004

(51) Int. Cl. H04B 1/08

(52) U.S. Cl. 455/347

(57) ABSTRACT

A door latch (20) for a compartment (11) for a portable product housing (10) includes an outer shell (14) to capture the door latch, to capture a spring mechanism (40), and to enable the door latch to translate on the portable product housing. The door latch further includes an inner latch piece (12) to rotate while remaining captured by the outer shell and to create engagement between the door latch and the portable product housing while preventing disengagement. The outer shell can further capture the inner latch piece and the inner latch piece can further include a feature (18) for preventing over-rotation in both a locked and an unlocked position. The door latch can be made using double shot molding or in-mold assembly techniques. Operationally, the door latch can translate on the portable product housing by traversing a slot (30) using a locking tooth (17) on the inner latch piece.

### FIELD OF THE INVENTION

This invention relates generally to latches, and more particularly to a latch and associated product housing manufactured using in-mold assembly techniques.

### BACKGROUND OF THE INVENTION

Cell phones, for the most part, use batteries that are replaceable by the end user. This allows the user to choose between various battery sizes, and to replace a battery that is out of charge with a fresh battery. The battery is typically captured by the phone, and covered with a battery door. In some cases the cosmetic surfaces of the battery door are incorporated into the battery geometry. In both cases it is usually possible to bump the battery door in some way that causes it to open or disengage, allowing the battery to come out of the phone. In a worst-case scenario the battery door as well as the battery itself could be lost without the knowledge of the user. This creates a perception of poor quality and causes serious customer dissatisfaction. Although door latches are small components in portable electronic products, no existing door latch utilizes in-mold assembly techniques to provide a high quality locking mechanism.

### SUMMARY OF THE INVENTION

Embodiments in accordance with the present invention provide a locking door latch that prevents accidental removal of the door. In a first embodiment of the present invention, a door latch for a compartment for a portable product housing can include an outer shell arranged and constructed to capture the door latch to the portable product housing, to capture a spring mechanism, and to enable the door latch to translate on the portable product housing. The door latch can further include an inner latch piece arranged and constructed to rotate while remaining captured by the outer shell and create engagement between the door latch and the portable product housing that prevents a disengaging motion. The outer shell can be further arranged and constructed to capture the inner latch piece whereas the inner latch piece can be further arranged and constructed to include a feature for rotating the inner latch piece. The inner latch piece can further include a feature for preventing over-rotation such as a rib on the inner latch piece that can prevent over-rotation in both a locked and an unlocked position. The door latch can be made using double shot molding or in-mold assembly techniques. In this regard, the outer shell can be constructed of a first material and the inner latch piece can be constructed of a second material. Operationally, the door latch can be captured by the portable product housing and can translate on the portable product housing by traversing a slot including a c-shaped slot using a locking tooth on the inner latch piece. The door latch can lock a compartment door in a first position and completely unlock the compartment door without further user intervention. Further note, the portable product can be a mobile radio and the compartment can be a battery compartment.

In a second embodiment of the present invention, a portable product, can include a portable product housing having a compartment and a removable compartment door and a door latch for the compartment door for the portable product housing. The door latch can include an outer shell arranged and constructed to capture the door latch to the portable product housing, to capture a spring mechanism, and to enable the door latch to translate on the portable product housing. The door latch can further include an inner latch piece arranged and constructed to rotate while remaining captured by the outer shell and create engagement between the door latch and the portable product housing that prevents a disengaging motion.

Other embodiments, when configured in accordance with the inventive arrangements disclosed herein, can include a wide varying number of embodiments all contemplated within the scope and spirit of the appended claims.

### BRIEF DESCRIPTION OF THE DRAWINGS

FIG. 1 is a partial perspective view of a portable product housing having a door latch in accordance with an embodiment of the present invention.

FIG. 2 is an enlarged perspective view of the door latch with a coin in a slot of the door latch in accordance with an embodiment of the present invention.

FIG. 3 is a plan view of the portable product housing of FIG. 1 without the door latch.

FIG. 4 is a perspective view of the portable product housing illustrating a c-shaped slot in accordance with an embodiment of the present invention.

FIG. 5 is a perspective view of the portable product housing illustrating the door latch in the slot in an unlocked position in accordance with an embodiment of the present invention.

FIG. 6 is an enlarged view of a portion of FIG. 5 illustrating the door latch in the slot of the portable product housing.

FIG. 7 is a perspective view of the portable product housing illustrating the door latch in the slot in a locked position in accordance with an embodiment of the present invention.

FIG. 8 is an enlarged view of a portion of FIG. 7 illustrating the door latch in the slot of the portable product housing.

FIG. 9 is a perspective view of a first portion of the door latch in accordance with an embodiment of the present invention.

FIG. 10 is another perspective view of the first portion of the door latch of FIG. 9.

FIG. 11 is a perspective view of a second portion of the door latch in accordance with an embodiment of the present invention.

FIG. 12 is another perspective view of the second portion of the door latch of FIG. 11.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

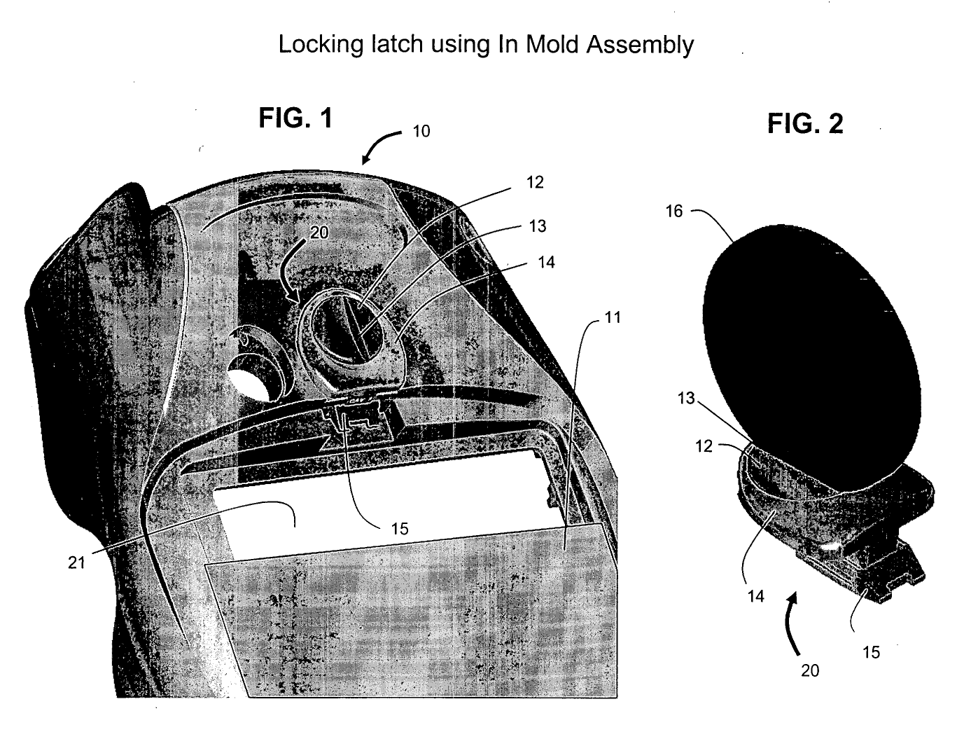

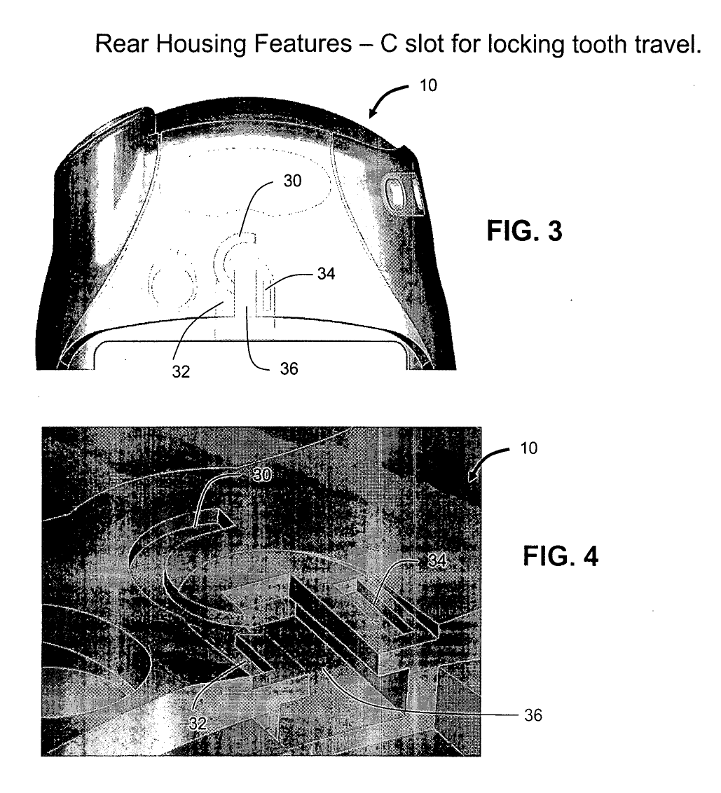

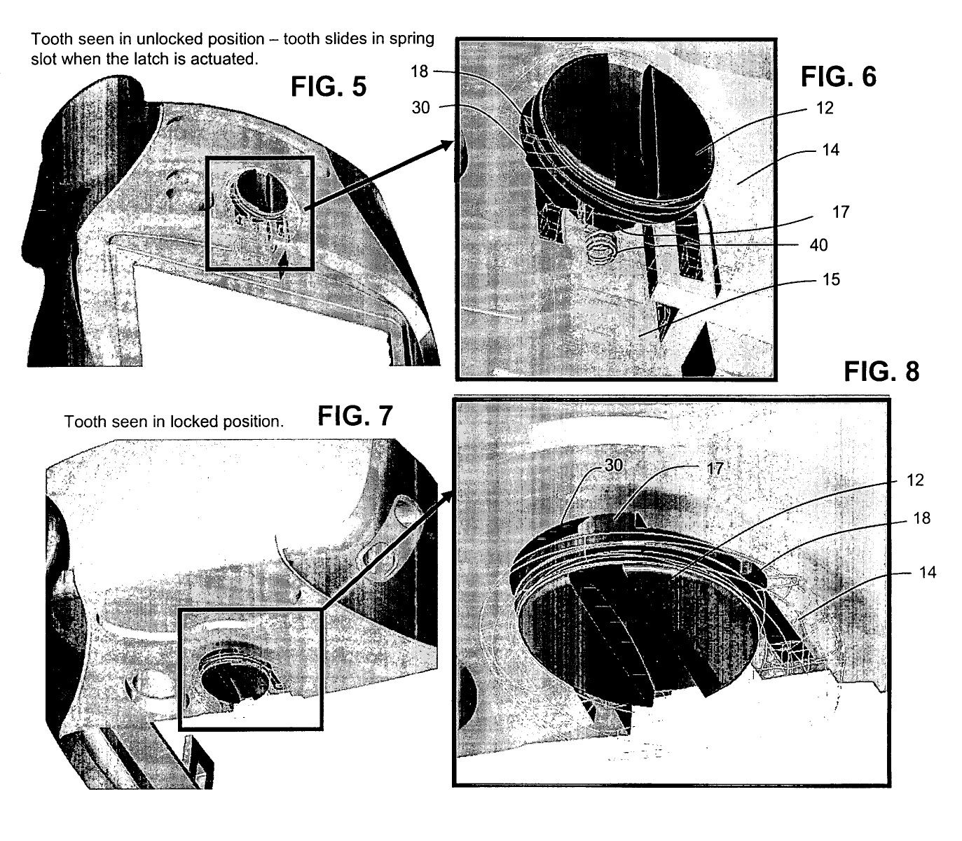

Referring to FIGS. 1 through 12, a portable product housing 10 is shown having a door latch 20 for a compartment 21. The door latch 20 can include an outer shell 14 arranged and constructed to capture the door latch 20 to the portable product housing 10, to capture a spring mechanism 40 and 93 (see FIGS. 6,9 and 9), and to enable the door latch to translate (see FIGS. 3, 4 and 12) on the portable product housing 10. The door latch 20 can further include an inner latch piece 12 arranged and constructed to rotate while remaining captured by the outer shell 14 and create engagement between the door latch 20 and the portable product housing 10 that prevents a disengaging motion. The outer shell 14 can be further arranged and constructed to capture the inner latch piece 12 whereas the inner latch piece 12 can be further arranged and constructed to include a feature 13 for rotating the inner latch piece such as a slot that can enable a coin 16 for example to rotate the inner latch piece 12. The inner latch piece 12 can further include a feature 18 as shown in FIGS. 11 and 12 for preventing over-rotation such as a rib on the inner latch piece 12 that can prevent over-rotation in both a locked and an unlocked position. The feature (rib) 18 can work in conjunction with stops 95 and 96 in the outer shell 14 as illustrated in FIG. 10 to prevent over-rotation. The door latch 20 can be made using double shot molding or in-mold assembly techniques. In this regard, the outer shell 14 can be constructed of a first material and the inner latch piece 12 can be constructed of a second material. Operationally, the door latch 20 can be captured by the portable product housing 10 and can translate on the portable product housing by traversing a slot (30, 32, 34, and 36) including a c-shaped slot 30 (as shown in FIGS. 3 and 4) using a locking tooth 17 on the inner latch piece as illustrated in FIG. 12. The door latch can lock a compartment door in a first position as illustrated in FIGS. 7 and 8 and completely unlock the compartment door without further user intervention as shown in FIGS. 5 and 6. Further note, the portable product can be a mobile radio and the compartment can be a battery compartment.

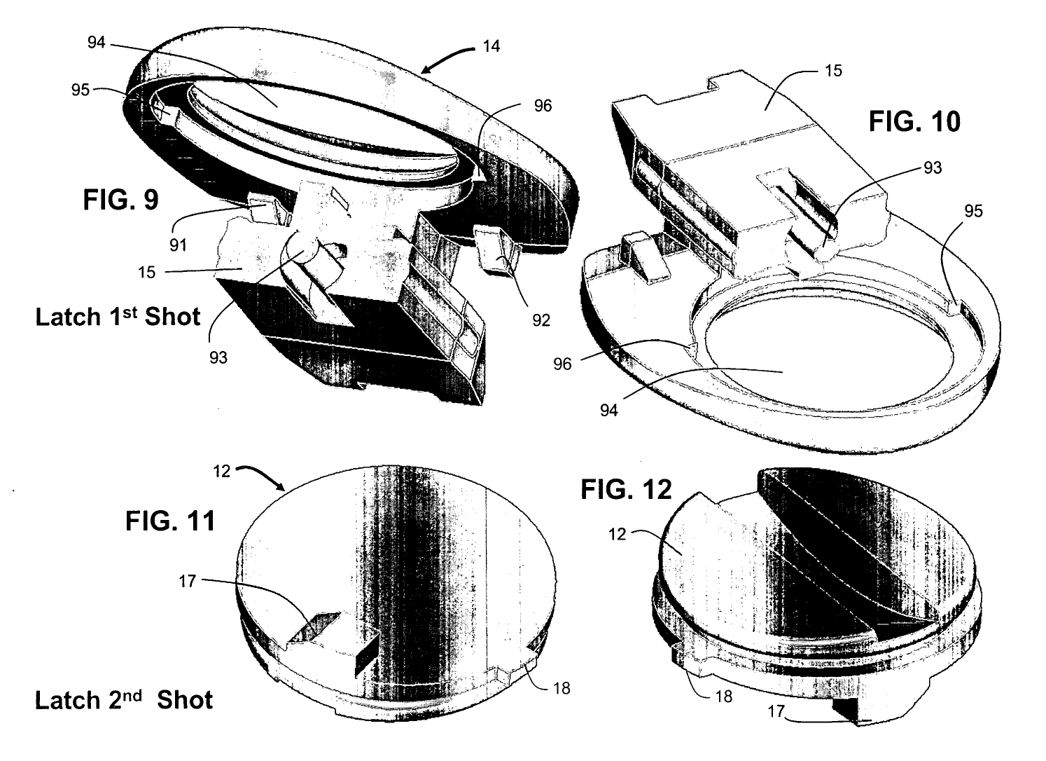

In one embodiment, the door latch can be created using In-Mold Assembly (IMA) techniques which allows the locking features to be incorporated in a standard size latch body. As discussed above, the door latch can generally include two major components. The first component, the outer shell 14, can give the door latch 20 its shape, provide features 15 to capture the latch in a housing 10 (via slot 30), provide features 93 to capture a spring mechanism 40, provide bearing surfaces 91 and 93 as shown in FIG. 9 for the door latch 20 (when assembled) to translate on in the housing 10, and provide features that capture the inner latch piece in an aperture 94 of the outer shell 14. The second component of the door latch 20 is the inner latch piece 12 which provides features (17) which allow it to rotate while keeping it captive in the outer shell, features (13) used to rotate the latch such as a coil slot, features used to create engagement between the latch and the housing thereby preventing any disengaging motion, and features (18) to control the range of motion of the inner piece to prevent over-rotation. Rotating the coin 16 moves the tooth 17 from its unlocked position to its locked position. When the latch is unlocked, the tooth 17 slides in a slot 36 (and slots 32 and 34) in the product housing 10 allowing the door latch 20 to engage and disengage freely. When the latch 20 is locked, the latch 20 engages a second slot 30 (a C shaped slot that it travels in to reach its locked position) preventing the latch 20 to disengage. A latch built in this manner also does not open any water paths into the product housing.

Embodiments in accordance with this invention can utilize the strengths of In-mold assembly to provide a locking latch that is not significantly bigger than existing latches. In this regard, using In-mold assembly techniques in a door latch assembly can satisfy the functional aspects by preventing the door latch from opening accidentally while providing sufficient flexibility to change the aesthetic aspects of the product housing and the door latch as desired.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A door latch for a compartment for a portable product housing, comprising:
an outer shell arranged and constructed to capture the door latch to the portable product housing, to capture a spring mechanism, and to enable the door latch to translate on the portable product housing; and
an inner latch piece arranged and constructed to rotate while remaining captured by the outer shell and create engagement between the door latch and the portable product housing that prevents a disengaging motion.

2. The door latch of claim 1, wherein the outer shell is further arranged and constructed to capture the inner latch piece.

3. The door latch of claim 1, wherein the inner latch piece is further arranged and constructed to include a feature for rotating the inner latch piece.

4. The door latch of claim 3, wherein the inner latch piece is further arranged and constructed to include a feature for preventing over-rotation.

5. The door latch of claim 4, wherein the feature for preventing over-rotation comprises a rib on the inner latch piece to prevent over-rotation in both a locked and unlocked position.

6. The door latch of claim 1, wherein the door latch is made using double shot molding.

7. The door latch of claim 1, wherein the door latch is made using in-mold assembly techniques.

8. The door latch of claim 1, wherein the outer shell is constructed of a first material and the inner latch piece is constructed of a second material.

9. The door latch of claim 1, wherein the portable product is a mobile radio and the compartment is a battery compartment.

10. The door latch of claim 1, wherein the door latch is captured by the portable product housing translates on the portable product housing by traversing a slot including a c-shaped slot using a locking tooth on the inner latch piece.

11. The door latch of claim 1, wherein the door latch locks a compartment door in a first position and completely unlocks the compartment door without further user intervention.

12. A portable product, comprising:
a portable product housing having a compartment and a removable compartment door; and
a door latch for the compartment door for the portable product housing, wherein the door latch comprises:
an outer shell arranged and constructed to capture the door latch to the portable product housing, to capture a spring mechanism, and to enable the door latch to translate on the portable product housing; and
an inner latch piece arranged and constructed to rotate while remaining captured by the outer shell and create engagement between the door latch and the portable product housing that prevents a disengaging motion.

13. The portable product of claim 12, wherein the outer shell of the door latch is further arranged and constructed to capture the inner latch piece and the inner latch piece is further arranged and constructed to include a feature for rotating the inner latch piece.

14. The portable product of claim 13, wherein the inner latch piece is further arranged and constructed to include a feature for preventing over-rotation comprising a rib on the inner latch piece to prevent over-rotation in both a locked and an unlocked position.

15. The portable product of claim 12, wherein the door latch is made using double shot molding.

16. The door latch of claim 1, wherein the door latch is made using in-mold assembly techniques.

17. The portable product of claim 12, wherein the outer shell is constructed of a first material and the inner latch piece is constructed of a second material.

18. The portable product of claim 12, wherein the portable product is a mobile radio and the compartment is a battery compartment.

19. The portable product of claim 12, wherein the door latch is captured by the portable product housing translates on the portable product housing by traversing a slot including a c-shaped slot using a locking tooth on the inner latch piece.

20. The portable product of claim 12, wherein the door latch locks a compartment door in a first position and completely unlocks the compartment door without further user intervention.
